(19) United States
(12) Patent Application Publication
(10) Pub. No.: US 2006/0068850 A1
(43) Pub. Date: Mar. 30, 2006

(54) Communication apparatus and software

(75) Inventors: Prem Kumar Chedella, Bangalore (IN); Nagaraju Bussa, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/527,546

(22) PCT Filed: Sep. 2, 2003
(86) PCT No.: PCT/IB03/03828

§ 371 Date: Mar. 11, 2005

(30) Foreign Application Priority Data
Sep. 16, 2002 (EP) 02078800.6

(51) Int. Cl. H04B 1/38

(52) U.S. Cl. 455/564; 455/550.1

(57) ABSTRACT

The communication apparatus (1) is capable of scheduling transmission of a message at a specified time to a specified communication address. The message, the time, and the communication address can be entered well before the specified time. The message is stored in a first storage means (7). The time and the communication address are stored in a second storage means (19). At the specified time, a timing device (13) triggers an auto-dialer (11) contained in a control unit (9) to initiate transmission of the message to the specified communication address, using a transmitter (3). The communication software enables a programmable apparatus, when executing said software, to function as a communication apparatus for scheduling transmission of a message to a specified communication address at a specified time.

The invention relates to a communication apparatus comprising a transmitter capable of transmitting an electromagnetic signal, a first interface for interfacing with a first storage means, and a control unit capable of urging the transmitter to transmit the electromagnetic signal and using the first interface to store a message entry in the first storage means. The invention further relates to communication software enabling, upon its execution, a programmable apparatus to function as a communication apparatus.

An embodiment of the communication apparatus is known from DE 196 00 209 A 1. The known apparatus combines the functionality of a mobile telephone with the functionality of a Dictaphone. A microphone and a speaker used to provide the mobile telephony function are also used to provide the Dictaphone functionality. An additional memory chip allows storage of voice messages, which is necessary to provide the Dictaphone functionality. It is a drawback of the known apparatus that only a user of the apparatus can recall a dictated voice message.

It is a first object of the invention to provide a communication apparatus of the type described in the opening paragraph, which enables a user of another apparatus to recall a dictated voice message.

It is a second object of the invention to provide communication software enabling, upon its execution, a programmable apparatus to function as a communication apparatus of the type described in the opening paragraph, which enables a user of another apparatus to recall a dictated voice message.

According to the invention, the first object is realized in that a second interface for interfacing with a second storage means is present; the control unit is capable of using the second interface to store, in the second storage means, a time entry specifying at least one of the elements date and time, an address entry specifying a communication address, and a relation between the time entry, the address entry, and the message entry; the control unit comprises an auto-dialer capable of initiating transmission of the message entry to the communication address when triggered; and a timing device is present, capable of trigging the auto-dialer in dependence upon the time entry. A user of another apparatus may be able to recall a dictated voice message by having it transmitted to him or her by a user of the apparatus of the invention. The user of the other apparatus may be able to store the dictated voice message and recall it at a later time.

Advantageously, the apparatus according to the invention enables a user to enter a message well before a pre-designated day and/or time and to schedule it to reach a communication address at this day and/or time, independent of supplementary services offered by a communication network. Scheduling a birthday greeting is an example of how a user could benefit from the apparatus according to the invention. When a user goes abroad, he will be able to send a birthday greeting as long as his telecom operator has a roaming agreement with a local telecom operator and his apparatus can use the local operator's communication network. It is not necessary for the local telecom operator to provide the same supplementary services as the user's own telecom operator.

In an embodiment of the apparatus of the invention, the control unit is capable of using the first interface to store an electromagnetic signal received from a microphone as a message entry in the first storage means. Advantageously, a microphone can be used to enter a message very quickly and a microphone may be very small and light and is therefore convenient for use in a mobile device. The control unit may also be capable of using the first storage means for storing as message entry text messages that have been entered on a keyboard. The electromagnetic signal may be digitized or processed in other ways before or after it is stored.

The apparatus may comprise an element allowing transmission to a wireless network. A mobile phone and a personal digital assistant (PDA) with a wireless LAN CompactFlash card are examples of apparatus that comprise such an element. Advantageously, apparatus that comprise such an element do not require the presence of a wire in order to allow transmission. Additionally, a user of the apparatus may be able to move the apparatus over a long distance while being able to continue transmitting. The apparatus may also comprise an element allowing transmission over wired lines, e.g. over electrical wiring or optical fibers.

In an embodiment of the apparatus of the invention, the apparatus comprises the first storage means and the second storage means. Advantageously, no other devices need to be carried around by a user. Alternatively, the first, the second or both the first and the second storage means are comprised in an external device. The first and the second storage means may be physically or logically different parts of the same hardware. The first and the second interface may be physically or logically different parts of the same hardware.

The control unit may be capable of using the second interface to store, in the second storage means, multiple address entries and a relation between the message entry and the multiple address entries. This feature allows a user to schedule a message to multiple communication addresses.

The control unit capable of using the second interface to store, in the second storage means, multiple time entries and a relation between the multiple address entries and the multiple time entries. This feature enables a user to specify for each communication address at which point of time the message should be transmitted.

The transmitter may be capable of transmitting the message entry with a prefix indicating that a message will follow. This feature allows a person being called to distinguish between a real-time communication and a message. A real-time communication may be a telephone call, a videoconference call, or a chat session.

The prefix may comprise an electromagnetic signal received from a microphone. This feature allows a user of a regular telephone to distinguish between an incoming call and an incoming voice message.

The apparatus may comprise a speech recognizer recognizing at least one of the entries date, address, and message. Advantageously, the apparatus does not require the presence of a keyboard, while allowing quick and convenient entry of data. A keyboard may take up a relatively large amount of space on a mobile apparatus.

The control unit may be capable of attempting transmission to the communication address several times in order to successfully complete transmission of the message. Advantageously, a message will be delivered even if the apparatus with the specified communication address is temporarily busy and therefore temporarily unable to receive the message.

The control unit may be capable of detecting communication with a machine and stopping transmission of the message if communication with a machine is detected. The machine may provide a voicemail function. The control unit may be capable of detecting communication with the voicemail function and starting transmission of the message when it can be recorded by the voicemail function. The control unit may, for example, wait for a period of silence. The control unit may be capable of stopping transmission a pre-defined number of times before it proceeds with transmission of the message to the voicemail function.

The apparatus may be capable of generating a notification when the transmitter has successfully completed transmission of the message. The notification may comprise audio, video, or text. The notification may comprise a date and time at which the message was successfully transmitted. The notification is convenient for a user when discussing the message in the future. If the message could not be delivered successfully, a user may need to find another way of communicating the contents of the message.

According to the invention, the second object is realized in that the communication software comprises a function for receiving a time entry specifying at least one of the elements date and time, an address entry specifying a communication address, and a message entry; and a function for transmitting the message entry to the communication address depending on the time entry.

These and other aspects of the apparatus and software of the invention will be further elucidated and described with reference to the drawing, in which:

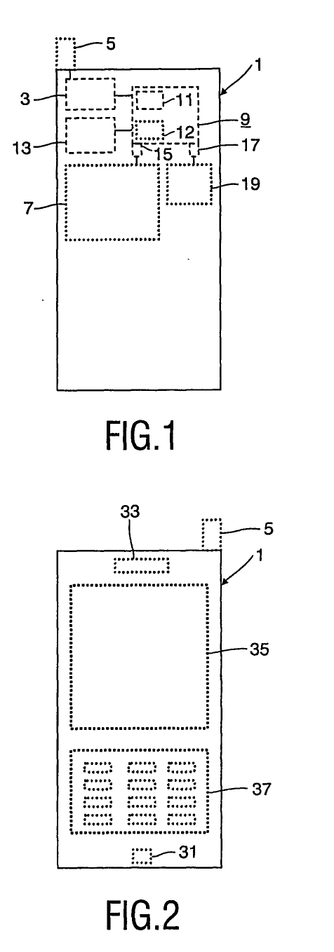

FIG. 1 is a rear view of the apparatus;

FIG. 2 is a front view of the apparatus of FIG. 1;

Elements within the drawing having similar or corresponding features are identified by the same reference numerals.

The apparatus 1 of FIG. 1 and FIG. 2 is a communication apparatus comprising a transmitter 3 which is capable of transmitting an electromagnetic signal, a first interface 15 for interfacing with a first storage means 7, and a control unit 9 which is capable of using the transmitter 3 to transmit the electromagnetic signal and using the first interface 15 to store a message entry in the first storage means 7. The control unit 9 may be a microprocessor. The apparatus further comprises a second interface 17 for interfacing with a second storage means 19. The control unit 9 is capable of using the second interface 17 to store, in the second storage means 19, a time entry specifying at least one of the elements date and time, an address entry specifying a communication address, and a relation between the time entry, the address entry, and the message entry. The first storage means 7 and the second storage means 19 may comprise a non-volatile random access memory, magnetic media, or optical media. The first interface 15 and/or the second interface 17 may be a memory bus, an IDE interface, or an IEEE 1394 interface. The address entry may comprise a phone number or an e-mail address. The control unit 9 comprises an auto-dialer 11 for initiating transmission of the message entry to the communication address when triggered. A timing device 13 is provided to trigger the auto-dialer 11 in dependence upon said time entry. The timing device 13 may keep track of time itself or may obtain time-based information from an external source. Time-based information may comprise time and date.

The apparatus may comprise a microphone 31 shown in FIG. 2 producing an electromagnetic signal allowing real-time audio communication. The electromagnetic signal can be stored as message entry by the storage means 7.

The apparatus may comprise an element allowing transmission to a wireless network. Transmitter 3 may be a radio frequency transmitter and may comprise one or more chips. Transmitter 3 may use optional antenna 5 to transmit to a wireless network.

The apparatus comprises the first storage means 7 and optionally the second storage means 19. The control unit 9 can use the second interface 17 to store, in the second storage means 19, multiple address entries and a relation between the message entry and the multiple address entries. The control unit 9 can use the second interface 17 to store, in the second storage means 19, multiple time entries and a relation between the multiple address entries and the multiple time entries. The control unit 9 can also store, in the second storage means 19, a relation between a single address entry and multiple time entries. This enables a user to send the same birthday greeting every year. The transmitter 3 can transmit the message entry with a prefix indicating that a message will follow. The prefix may comprise an electromagnetic signal received from microphone 31 shown in FIG. 2.

The apparatus, see FIG. 2, may further comprise a speaker 33, a display 35, and a keyboard 37. The speaker 33 can be used to reproduce a stored message that has been entered, using the microphone 31. The speaker 33 can also be used to allow real-time audio communication. The keyboard 37 can be used to enter a time and an address. The keyboard 37 can also be used to enter text messages. Alternatively, data can be entered, using speech recognition. The control unit 9 shown in FIG. 1 comprises an optional speech recognizer 12 shown in FIG. 1, which, can recognize speech received from microphone 31. The speech recognizer 12 shown in FIG. 1 can recognize at least one of the entries date, address and message. The display 35 can be used to review data entered with the keyboard 37 or the microphone 31. The display 35 may be a LED display or a LCD display. The keyboard 37 or the speech recognizer 12 may also be used to edit at least one of the entries date, address and message.

The control unit 9 shown in FIG. 1 can attempt transmission to the communication address several times in order to successfully complete transmission of the message. The control unit 9 shown in FIG. 1 can detect communication with a machine and stop transmission of the message if communication with a machine is detected. A notification may be generated when the transmitter 3 shown in FIG. 1 has successfully completed transmission of the message. This notification may be shown on the display 35 or played, using the speaker 33.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Software’ is to be understood to mean any software product stored on a computer-readable medium, such as a floppy disk, downloadable via a network, such as the Internet, or marketable in any other manner.

1. A communication apparatus (1), comprising:
a transmitter (3) capable of transmitting an electromagnetic signal;
a first interface (15) for interfacing with a first storage means (7);
and a control unit (9) capable of urging the transmitter (3) to transmit the electromagnetic signal and using the first interface (15) to store a message entry in the first storage means (7), characterized in that:
a second interface (17) for interfacing with a second storage means (19) is present;
the control unit (9) is capable of using the second interface (17) to store, in the second storage means (19), a time entry specifying at least one of the elements date and time, an address entry specifying a communication address, and a relation between the time entry, the address entry, and the message entry;
the control unit (9) comprises an auto-dialer (11) capable of initiating transmission of the message entry to the communication address when triggered; and
a timing device (13) is present, capable of trigging the auto-dialer (11) in dependence upon the time entry.

2. An apparatus as claimed in claim 1, characterized in that the control unit (9) is capable of using the first interface (15) to store an electromagnetic signal received from a microphone (31) as a message entry in the first storage means (7).

3. An apparatus as claimed in claim 1, characterized in that it comprises an element (3, 5) allowing transmission to a wireless network.

4. An apparatus as claimed in claim 1, characterized in that it comprises the first storage means (7) and the second storage means (19).

5. An apparatus as claimed in claim 1, characterized in that the control unit (9) is capable of using the second interface (17) to store, in the second storage means (19), multiple address entries and a relation between the message entry and the multiple address entries.

6. An apparatus as claimed in claim 5, characterized in that the control unit (9) is capable of using the second interface (17) to store, in the second storage means (19), multiple time entries and a relation between the multiple address entries and the multiple time entries.

7. An apparatus as claimed in claim 1, characterized in that the transmitter (3) is capable of transmitting a message entry with a prefix indicating that a message will follow.

8. An apparatus as claimed in claim 7, characterized in that the prefix comprises an electromagnetic signal received from a microphone (31).

9. An apparatus as claimed in claim 1, characterized in that it comprises a speech recognizer (12) recognizing at least one of the entries date, address and message.

10. An apparatus as claimed in claim 1, characterized in that the control unit (9) is capable of attempting transmission to the communication address several times in order to successfully complete transmission of the message.

11. An apparatus as claimed in claim 10, characterized in that the control unit (9) is capable of detecting communication with a machine and stopping transmission of the message if communication with a machine is detected.

12. An apparatus as claimed in claim 1, characterized in that it is capable of generating a notification when the transmitter (3) has successfully completed transmission of the message.

13. Communication software enabling, upon its execution, a programmable apparatus to function as a communication apparatus, comprising:
a function for receiving a time entry specifying at least one of the elements date and time, an address entry specifying a communication address, and a message entry; and
a function for transmitting the message entry to the communication address depending on the time entry.

14. Communication software as claimed in claim 13, characterized in that it is stored on a record carrier.
